(19) United States
(12) Patent Application Publication
(10) Pub. No.: US 2013/0198001 A1
(43) Pub. Date: Aug. 1, 2013

(54) OPT-IN SYSTEM FOR PROMOTIONAL MESSAGES

(71) Applicants: Keith Teare, Palo Alto, CA (US); Kevin Lloyd Nilson, Mountain View, CA (US); Abdelmonaim Remani, Capitola, CA (US); Alexander Lvovich Komarov, Melbourne (AU)

(72) Inventors: Keith Teare, Palo Alto, CA (US); Kevin Lloyd Nilson, Mountain View, CA (US); Abdelmonaim Remani, Capitola, CA (US); Alexander Lvovich Komarov, Melbourne (AU)

(21) Appl. No.: 13/666,858

(22) Filed: Nov. 1, 2012

Related U.S. Application Data
(60) Provisional application No. 61/554,284, filed on Nov. 1, 2011.
(60) Provisional application No. 61/609,046, filed on Mar. 9, 2012.

(51) Int. Cl. G06Q 30/02

(52) U.S. Cl. CPC G06Q 30/0257
USPC 705/14.55

(57) ABSTRACT

A system, method, and computer readable medium are disclosed for utilizing the address book or contact list on a consumer computer, such as a mobile device, to provide consumers with a means of opting-in to or opting-out of offers, promotions and other messages from a brand, merchant, or other vendor.

### CROSS-REFERENCE To RELATED APPLICATIONS

This application claims the benefit of U.S. Provisional Patent Application No. 61/554,284, filed on Nov. 1, 2011, and U.S. Provisional Patent Application No. 61/609,046, filed on Mar. 9, 2012, each of which is incorporated by reference in its entirety.

### BACKGROUND

1. Technical Field

The disclosure generally relates to the field of promotional messaging, and in particular enabling consumers to opt-in to, and opt-out of, receiving promotional messages from individual brands.

2. Description of the Related Art

Marketers have long sought a method of directly communicating with consumers who want to hear from a particular brand. Existing means of doing so generally involve guess work about the consumers' willingness to receive information, promotions, or offers, and also involve a degree of uncertainty about whether messages are delivered to, and read by, the consumers. Consumers have also desired a method of permitting messages from brands they like to be received while blocking unwanted messages from other brands.

### BRIEF DESCRIPTION OF DRAWINGS

The disclosed embodiments have other advantages and features that will be more readily apparent from the detailed description, the appended claims, and the accompanying figures (or drawings). A brief introduction of the figures is below.

FIG. 1 illustrates one embodiment of components of an example machine able to read instructions from a machine-readable medium and execute them in a processor (or controller).

FIG. 2 is a high-level block diagram illustrating a networked computing environment, according to one embodiment.

FIG. 3 is a flow chart illustrating a method by which a brand can create a campaign of promotional messages to consumers on an opt-in basis, according to one embodiment.

FIG. 4 is a flow chart illustrating a method by which a consumer can receive promotional messages from a brand on an opt-in basis, without consumer data being stored in the cloud, according to one embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

As stated above, marketers have long sought a method of directly communicating with consumers who want to hear from a particular brand. A system, method and computer program product are disclosed herein that enable brands or other merchants to make themselves known to consumers via a dashboard, a page on a mobile device, a page on a web site, or the like. The consumer can then, if desired, opt-in to receiving messages from the brand or merchant by adding the brand or merchant to an address book or contact list on their mobile device. These messages may take the form of offers, promotions, information or any other content and may include any media type. Once provisioned the brand or merchant can leverage the service to send messages to these consumers. In one embodiment, additional metadata is added to the address book describing relationships between the address book owner and entities in the address book. In another embodiment, such information describing relationships between the address book owner and entities in the address book is stored on the mobile device separately from the address book.

### Computing Machine Architecture

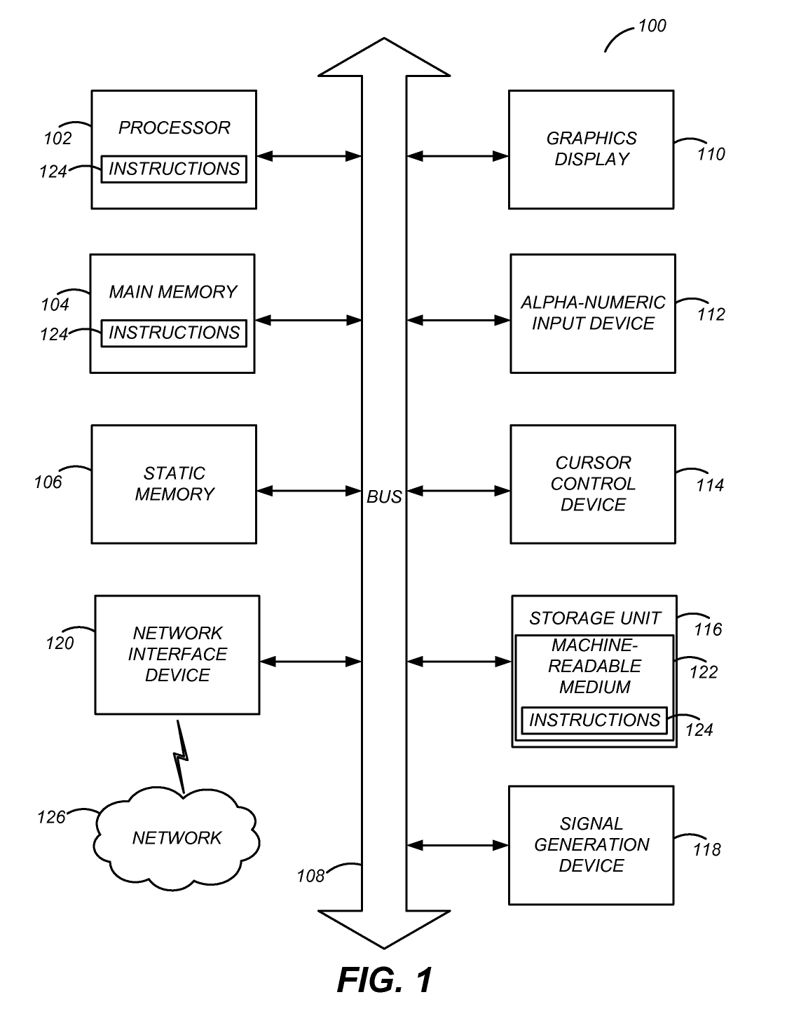

FIG. 1 is a block diagram illustrating components of an example machine able to read instructions from a machine-readable medium and execute them in a processor (or controller). Specifically, FIG. 1 shows a diagrammatic representation of a machine in the example form of a computer system 100 within which instructions 124 (e.g., software or program code) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 124 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 100 includes a processor 102 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 104, and a static memory 106, which are configured to communicate with each other via a bus 108. The computer system 100 may further include graphics display unit 110 (e.g., a plasma display panel (PDP), a liquid crystal display (LCD), a projector, or a cathode ray tube (CRT)). The computer system 100 may also include alphanumeric input device 112 (e.g., a keyboard), a cursor control device 114 (e.g., a mouse, a trackball, a joystick, a motion sensor, or other pointing instrument), a storage unit 116, a signal generation device 118 (e.g., a speaker), and a network interface device 120, which also are configured to communicate via the bus 108.

The storage unit 116 includes a machine-readable medium 122 on which is stored instructions 124 embodying any one or more of the methodologies or functions described herein. The instructions 124 may also reside, completely or at least partially, within the main memory 104 or within the processor 102 (e.g., within a processor's cache memory) during execution thereof by the computer system 100, the main memory 104 and the processor 102 also constituting machine-readable media. The instructions 124 may be transmitted or received over a network 126 via the network interface device 120.

While machine-readable medium 122 is shown in an example embodiment to be a single medium, the term “machine-readable medium” should be taken to include a single medium or multiple media (e.g., a centralized or distributed database, or associated caches and servers) able to store instructions (e.g., instructions 124). The term “machine-readable medium” shall also be taken to include any medium that is capable of storing instructions (e.g., instructions 124) for execution by the machine and that cause the machine to perform any one or more of the methodologies disclosed herein. The term “machine-readable medium” includes, but not be limited to, data repositories in the form of solid-state memories, optical media, and magnetic media.

### System Overview

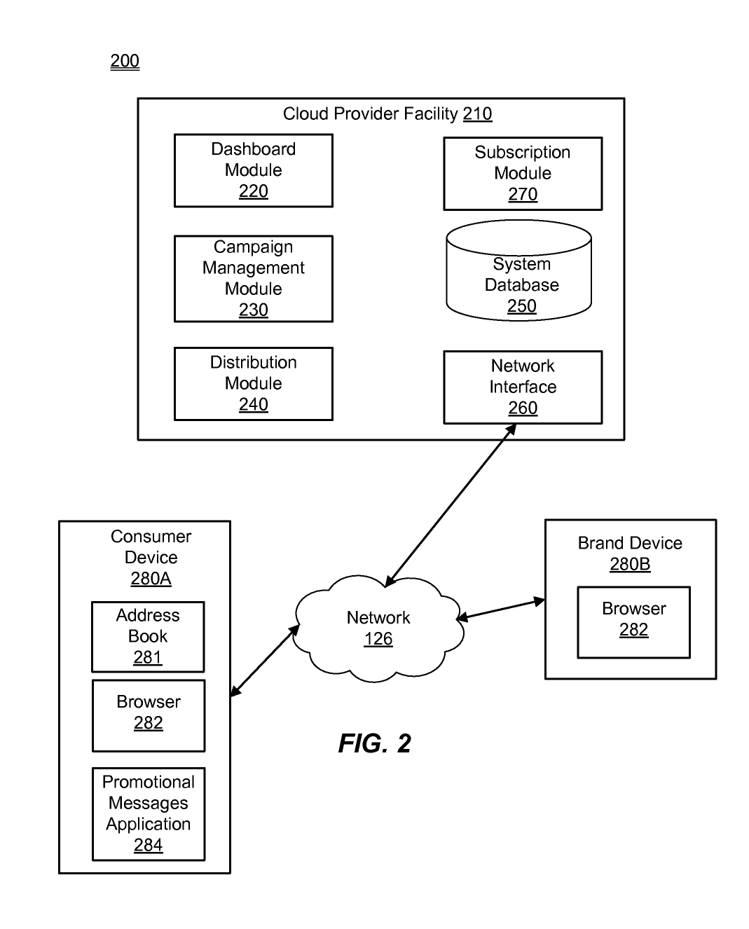

Referring now to FIG. 2, one embodiment of a networked computing environment 200 in which a brand can provide promotional messages to consumers on an opt-in basis is shown. The networked computing environment 200 includes consumer devices 280A (of which one is shown for exemplary purposes), brand devices 280B (of which one is shown for exemplary purposes), and a cloud provider facility 210, all of which are connected via a network 126.

The network 126 is typically the Internet, but can be any network, including but not limited to any combination of a LAN, a MAN, a WAN, a mobile, a wired or wireless network, a private network, or a virtual private network. The cloud provider facility 110 is connected to the network 126 through a network interface 260.

As discussed above, only a single consumer device 280A is shown, but in practice there are many (e.g., millions of) consumer devices 280A that can communicate with and use the cloud provider facility 210. Typically, consumer devices 280A are smart phones, but can be any device configured to receive promotional message, including PDAs, desktop PCs, tablets, laptop PCs, and pagers. The illustrated consumer device 280A includes an address book 281, a browser 282, and a promotional messages application 284. The address book 281 contains a digital list of contacts for one or more users associated with the consumer device 280A. The browser 282 enables webpages and other content accessed via the network 126 to be displayed on the consumer device 280A. In one embodiment, the promotional messages application 284 is specialized software (e.g., a smartphone app) that provides an interface with the cloud provider facility 110. The interface enables a user to opt-in to receiving promotional messages from specific brands and/or receive those promotional messages for display at the consumer device 280A. In another embodiment, the promotional messages application 284 functionality is combined with the browser 282. In this embodiment, the browser 282 accesses a webpage at which a consumer can opt-in to receiving promotional messages from specific brands and/or view promotional messages from the specific brands.

Similarly, only a single brand device 280B is shown, but in practice there are many (e.g., thousands or even millions of) brand devices 280B that can be used by brands to create and manage promotional campaigns. Typically, the brand device 280B will be a desktop PC or laptop, but other computing devices may be used. The brand device 280B includes a browser 282. The browser 282 enables webpages and other content accessed via the network 126 to be displayed on the brand device 280B. In some embodiments, browser 282 includes a content player (e.g., a player capable of playing HTML5 video or FLASH™ video) or any other player adapted for the display of content stored by the cloud provider facility 210.

In the illustrated embodiment, the cloud provider facility 210 includes a dashboard module 220, a campaign management module 230, a subscription module 270, a distribution module 240, a system database 250, and a network interface 260. Other embodiments of the cloud provider facility 210 include different and/or additional modules. In addition, the functions may be distributed among the modules in a different manner than described herein. For example, in some embodiments, some or all of the system database 250 is distributed across consumer devices 280A. In this way, the amount of consumer data stored in the cloud is minimized, thus improving consumer privacy.

The dashboard module 220 provides a dashboard or page viewable at consumer devices 280A (e.g., mobile devices). Brands or other merchants can make themselves known to consumers via the dashboard or page, e.g., by providing a summary of the brand for display on the dashboard. A consumer can then add the brand or merchant to the address book 281 (or contact list) of a consumer device 280A associated with the consumer, such as a personal cell phone. Doing so is an explicit statement of a desire to opt-in to receiving promotional messages from the brand or merchant.

The subscription module 270 monitors the dashboard module 220 and/or data received relating to the address books 281 of consumer devices 280A for brands being added to and removed from the address books. As described above, when a consumer adds a brand to the address book 281 of a consumer device 280A, it is interpreted as an explicit statement of intent to opt-in to receiving promotional messages from the brand. Conversely, if a consumer removes a brand from the address book 281, it is interpreted as an explicit statement of intent to opt-out of receiving further promotional messages.

In an alternative embodiment, the consumer device 280A provides controls enabling a user to opt-out of receiving promotional messages from a brand without removing the brand from the address book 281. Thus, the consumer can later re-opt-in to receiving promotional messages from the brand directly from the address book 281, without having to locate the brand via the dashboard.

In some embodiments, the subscription module 270 maintains a subscription list of consumer IDs that are currently opted-in to each brand in the system database 250. As described previously, whether a consumer has given permission to receive promotional messages from a brand is determined by the address book 281 of the consumer's consumer device 280A (e.g., the consumer's smartphone). Any changes in the permissions granted by the consumer (e.g., by removing a brand contact from the address book 281) are sent to the cloud provider facility 210 and the system database 250 is updated. Thus, the “truth” regarding permissions in the system 200 is determined by the address books 281 of the consumer devices 280A in the system 200, not data stored at the cloud provider facility 210. In one such embodiment, the consumer's privacy is protected by using consumer IDs that are associated with demographic data about the consumer, and can be used to route promotional messages to the appropriate consumer device 280A, but that cannot be used to personally identify the consumer. In other embodiments, no data about the consumer or brands that have been opted-in to are stored at the cloud provider facility 210 at all.

The campaign management module 230 provides a brand dashboard, accessible using the browser 282 of a brand device 280B, with which a brand or merchant can create a promotional campaign. A campaign comprises a promotional message and a set of parameters. The promotional message can include combinations of media objects such as images, audio files, and videos, as well text. In some embodiments, the parameters include a choice between the campaign being public or private. When a campaign is created, the message and parameters are stored in the system database 250.

In a public campaign, the message is displayed in “public” places, such as on webpages, and the cost to the vendor is based on a number of views of the message. In some embodiments, a price cap is used. Once the cost to the brand reaches a pre-determined cap value, the campaign will automatically end to prevent further costs being accrued. In one such embodiment, the vendor is informed when the cap is reached (or about to be reached) and given the opportunity to raise the cap and continue the campaign. In one embodiment, a brand can access and amend cost information such as the price cap and number of messages displayed at any time by accessing the brand dashboard using a brand device 280B. One of skill in the art will recognize that other payment structures are possible for campaigns without deviating from the spirit and scope of this disclosure.

In a private campaign, the message is delivered to individual consumers, such as via a multi-media message delivered to the inbox of the consumer's cell phone, or by displaying user-specific advertisements as part of a dynamic webpage. The parameters for a private campaign include criteria describing who the brand wants to receive the message the campaign is targeting. This may include all kinds of demographic requirements of the recipient, such as age, gender, current location, salary level, interests, and the like.

The distribution module 240 compares the recipient criteria provided by the brand to demographic data stored in the system database 250 to identify consumers that meet the requirements. The campaign message is then delivered to consumers that are determined to meet the criteria. In one embodiment, the demographic data is used to personalize the promotional message. For example, if the promotional message relates to a particular store and the consumer has a GPS enabled device, the message may include the distance and directions to the nearest branch of the store.

In various embodiments, the cost to the brand for a private campaign is based on at least one of: the number of messages delivered; the number of messages opened; the number of consumers that add the brand from the dashboard; and combinations thereof. In one embodiment, a price cap similar to that described above with reference to public campaigns is used. One of skill in the art will recognize that other payment structures are possible for campaigns without deviating from the spirit and scope of this disclosure.

In some embodiments, whether the campaign is public or private, the brand receives (e.g., via the brand dashboard) analytics regarding the campaign. In one such embodiment, the analytics comprise aggregated data regarding the campaign, such as the number of consumers that have opted in to the brand, the total number of messages delivered, the proportion of delivered messages that have been read, usage of promotional offers included in the message, and the like. Thus, consumer privacy is protected, as the brand is provided only with aggregated statistics, and not specific information about individual consumers.

As previously mentioned, in one embodiment, no data about the consumer or brands that have been opted-in to are stored in the cloud at all. Instead, data regarding which brands a particular consumer has opted-in to are stored locally on a corresponding consumer device 280A. The consumer device 280A periodically (e.g., hourly, daily, etc.) or on demand (e.g., by an application running on the consumer device that is configured to display promotional messages) sends a request to the distribution module 240 for one or more promotional messages. The request identifies brands that are being followed (e.g., are present in the address book 281) by the consumer device 280A. Optionally, the request also includes a set of demographic parameters related to the consumer device 280A, e.g., the age of a user linked with the consumer device (e.g., the owner of a smart phone), the gender of the user, the location of the consumer device (e.g., a GPS position), a list of interests associated with the consumer device, and the like. The interests associated with a consumer device 280A can be provided manually by the user (e.g., by selecting from a list of options provided by the consumer dashboard), generated automatically (e.g., based on common characteristics between brands the user has opted-in to), or a mixture of manually provided and automatically generated interests.

On receiving the request, the distribution module 240 identifies one or more promotional messages from brands that the consumer device 280A is opted-in to. If the request includes demographic parameters, these are compared to the recipient criteria of the identified promotional messages. In one embodiment, promotional messages are selected only if an explicit match between the demographic parameters and the recipient criteria is identified. In another embodiment, promotional messages are selected unless a conflict is identified between the demographic parameters and the recipient criteria. In other embodiments, other selection methods are used. Regardless of the precise method used to select promotional messages, the selected promotional messages are sent to the consumer devices 280A for presentation (e.g., as an SMS text message, as data for display within a webpage by the browser 282 of the consumer device, as data for display within the promotional messages application 284, etc.).

### Exemplary Method for Creating a Campaign

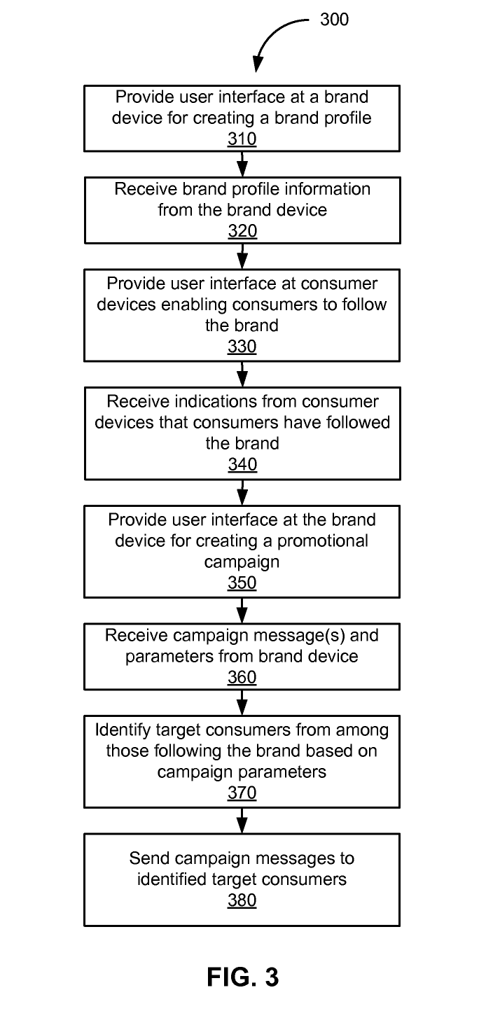

Referring now to FIG. 3, an exemplary method 300 is shown for the creation and operation of a promotional campaign by a brand, according to one embodiment. FIG. 3 attributes the steps of the method 300 to a cloud provider facility 210. However, some or all of the steps may be performed by other entities. In addition, some embodiments may perform the steps in parallel, perform the steps in different orders, or perform different steps.

The dashboard module 220 of the cloud provider facility 210 provides 310 a user interface for a brand device 280B (e.g., for display by the browser 282) that enables the brand to create a brand profile, for example, a brand dashboard that is accessible via the network 126 using a brand device 280B. In one embodiment, creating the brand profile includes providing brand profile information, such as contact details and a brand biography (e.g., a summary of the brand's products and/or services).

When a brand creates a profile, the dashboard module 220 receives 320 the brand profile information from the brand device 280B, via the network 126. In one embodiment, the brand profile information is stored in the system database 250 along with a brand identifier (brand ID) that uniquely identifies the brand in the system 200. The brand ID can be generated automatically (e.g., an ID number) or provided by the brand (e.g., the brand's trade name), subject to confirmation that the provided brand ID is unique.

The dashboard module 220 also provides 330 a user interface for consumer devices 280A (e.g., for display by the browser 282 or the promotional messages application 284) that enables consumers to view brand profiles and follow those from whom they are interested in receiving promotional messages. In one embodiment, the user interface includes a control that automatically adds a brand contact to the address book 281 of a consumer's consumer device 280A, when the control is selected. Thus, a consumer can follow the brand directly using the user interface, without having to manually add a brand contact to the address books 281 using the consumer device's built-in contact management interface.

Generally the brand will promote the brand profile, for example by providing a link to the profile on the brand's website and/or including a URL on physical promotional materials, such as billboards. In one embodiment, the dashboard module 220 provides a consumer dashboard that enables consumers to browse through brand profiles. The dashboard module 220 also provides search and/or filter functions to enables consumers to locate brands that they are interested in. For example, search/filter functions can provided to search for a specific brand, filter brand profiles by one or more brand categories (e.g., sportswear, book publishers, musicians, etc.), display brands similar to those already followed by the consumer, and the like.

When a consumer follows a brand, the subscription module 270 receives 340 an indication of the consumer and brand (e.g., a consumer ID and a brand ID). As described above with reference to FIG. 2, a consumer follows a brand by adding a brand contact to the address book 281 of a consumer device 280A. In one embodiment, software running on the consumer device 280A detects that a brand contact has been added to the address book 281 and notifies the subscription module 270, via network 126. In another embodiment, the dashboard module 220 at the cloud provider facility 210 detects a request to add a brand via the consumer dashboard and notifies the subscription module 270. In some embodiments, the brand is charged a fee each time a consumer opts-in to receiving promotional messages from the brand.

The campaign management module 230 provides 350 a user interface for a brand device 280B that enables the brand to create a promotional campaign. The brand provides one or more promotional messages and campaign parameters. In one embodiment, the campaign parameters include a time frame during which the promotional messages should be sent, a geographic region in which the promotional messages should be sent, a spending cap, and (optionally) consumer targeting criteria, such as demographic requirements. In another embodiment, the brand provides just a spending bap and the promotional messages are displayed publicly on webpages until the fees due reach the spending cap. In other embodiments, different combinations of campaign parameters are used. One of skill in the art will recognize that many such parameters can be applied without deviating from the spirit and scope of this disclosure.

When a brand creates a campaign, the campaign management module 230 receives 360 the one or more promotional messages the brand wishes to send during the campaign as well as the campaign parameters. In one embodiment, the one or more promotional messages and campaign parameters are stored in the system database 250. In another embodiment, the system database 250 stores information indicating where the promotional messages and parameters can be found (e.g., on a brand device 280B). In other embodiments, the one or more campaign messages and campaign parameters are stored in other locations or combinations of locations (e.g., the campaign parameters may be stored in the system database 250, but the promotional messages may be stored on a brand device 280B).

Once a campaign has been created, the distribution module 240 identifies 370 target consumers from among those that are following the brand, based on the campaign parameters. In one embodiment, the campaign parameters include demographic criteria (e.g., all females, aged 18-35, located within 50 miles of downtown San Francisco). The distribution module 240 filters the consumers that follow the brand to identify 370 all such consumers that also meet the demographic criteria. In some embodiments, the brand can provide more than one promotional message as part of a campaign. Each promotional message can be associated with a different set of campaign parameters. For example, the promotional campaign may wish to send one promotional message to consumers aged 11-18 and a second promotional message to consumers aged 19-30. Thus, the brand can tailor the promotional messages to specific demographic groups.

Once the target consumers have been identified 370, the distribution module 240 sends 380 promotional messages to identified target consumers. As described previously with reference to FIG. 2, the promotional messages can be sent 380 in many ways, including displaying the promotional message as part of a website and sending the promotional message to the inbox of a consumer's consumer device 280A. In one embodiment, a promotional message is sent 380 to every identified target consumer at a fixed time. In another embodiment, the promotional messages are sent 380 in batches over a period of time (e.g., 1000 every hour between 9 am and 5 pm). Regardless of the distribution message, the brand can be charged a fixed fee for the campaign, a per message sent fee, a per message received (e.g., opened, clicked on, replied to etc.) fee, or any combination of these fees.

In embodiments where a price cap can be used, it is possible that a campaign will not be allocated sufficient funds to send a promotional message to every identified target consumer. In one such embodiment, the distribution module 240 selects which of the identified target consumers to send 380 promotional messages to at random. As described above with reference to FIG. 2, the brand may be notified when a price cap is reached or approaching and provided an opportunity to increase the price cap to extend the campaign.

In another such embodiment, the brand provides ideal values for one or more campaign parameters, as well as a range. The distribution module 240 then selects which of the identified target consumers to send 380 promotional messages to based on how closely the identified target consumers match the ideal values. For example, the brand may wish to target consumers in their 30's, and provide an ideal value of 35. The distribution module 240 will first send 380 promotional messages to identified target consumers who are exactly 35, then those that are 34 or 36, then those that are 33 or 37, and so on, until the price cap is reached.

Exemplary Method with no Consumer Data Stored in the Cloud

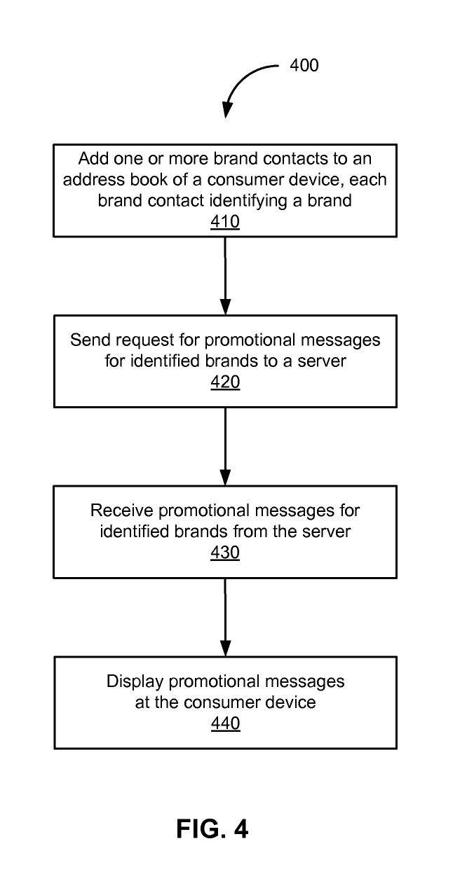

Referring now to FIG. 4, an exemplary method 400 is shown for providing promotional messages on an opt-in basis, according to one embodiment. FIG. 4 attributes the steps of the method 400 to a consumer device 280A. However, some or all of the steps may be performed by other entities. In addition, some embodiments may perform the steps in parallel, perform the steps in different orders, or perform different steps.

The method 400 begins with a consumer adding 410 one or more brand contacts to the address book 281 of a consumer device 280A. Each brand contact identifies a brand (e.g., with a brand ID) that the consumer wishes to follow, thereby opting-in to receiving promotional messages from the brand. In one embodiment, as described previously, the brand contact is added 410 from a consumer dashboard provided by the dashboard module 220 of the cloud provider facility 210, via the network 216. In other embodiments, the brand contacts are added 410 in other ways, such as using a link on the brand's website.

The consumer device 280A sends 420 a request for promotional messages to the cloud provider facility 210. The request identifies the one or more brands included in the consumer device's address book 281 (e.g., by including a list of brand IDs). The request may also include demographic data associated with the consumer request 280A. In one embodiment, the request for promotional messages is triggered by an application executing on the consumer device 280A (e.g., the browser 282, the promotional messages application 284, etc.) that includes instructions to display a promotional message (e.g., as part of a webpage). In another embodiment, the consumer device 280A sends 420 requests for promotional messages at regular intervals (e.g., hourly, daily, etc.).

The consumer device 280A receives 430 one or more promotional messages from the distribution module 240 of the cloud provider facility 210. The received promotional messages correspond to the brands included in the address book 281 of the consumer device 280A. In one embodiment, the consumer device 280A receives 430 all of the promotional messages created by brands in the address book 281 since the last request for promotional messages. In another embodiment, in which demographic data is included in the request, the distribution module 240 filters which promotional messages to send by comparing the demographic data with target demographic parameters for each promotional message, as described above with reference to FIG. 2 and FIG. 3. In other embodiments, other criteria are used to determine which promotional messages are sent to the consumer device 280A. Note that the only information required by the distribution module 240 to select promotional messages to send to the consumer device 280A is that included in the request. Thus, no information about the consumer device 280A is stored at the cloud provider facility 210 in advance, and as long as the request is not stored, no information about the consumer device is retained at the cloud provider facility after the promotional messages have been provided.

Once the promotional messages have been received 430, the consumer device 280A displays 440 the promotional messages to the consumer. In one embodiment, the promotional messages are displayed 440 by delivering the messages as SMS and/or multi-media messages to an inbox of the consumer device 280A. In another embodiment, one or more of the promotional messages are displayed in the browser 282 in conjunction with a webpage (or within another application running on the consumer device 280A, such as the promotional messages application 284). In cases where there are more promotional messages available than space within the application to display them, the promotional messages displayed can be selected in any appropriate manner (e.g., randomly, oldest first, newest first, etc.). Alternatively, the request 420 can include a specified number of promotional messages required and the specified number of promotional messages can be selected by the distribution module 240.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., instructions or program code, e.g., 124, embodied on a machine-readable medium, e.g., 122 or 102) or hardware modules. A hardware module is tangible unit capable of performing certain operations and may be configured or arranged in a certain manner. In example embodiments, one or more computer systems (e.g., a standalone, client or server computer system, e.g., 100) or one or more hardware modules of a computer system (e.g., 100 with a processor or a group of processors, e.g., 102) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors (e.g., 102) may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, e.g., 102, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors, e.g., 102, or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory (e.g., 104, 106), non-volatile memory (e.g., 122), or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for an opt-in system for sending promotional messages to consumers through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for providing an opt-in system for promotional messages, the method, executed by one or more processors, comprising:
receiving, from a consumer device, at least a portion of an address book of the consumer device, the at least a portion of the address book including a brand contact that has been added to the address book, the brand contact identifying a selected brand and indicating permission for the selected brand to send promotional messages to the consumer device;
receiving, from a brand device, a request for a campaign, the request comprising a promotional message and a brand identifier, the brand identifier uniquely identifying the brand; and
transmitting, to the consumer device, the promotional message, responsive to the brand identifier corresponding to the selected brand identified by the brand contact.

2. The computer-implemented method of claim 1, further comprising:
receiving, from a consumer device, a request for promotional messages, wherein the promotional message is sent responsive to the request.

3. The computer-implemented method of claim 1, wherein transmitting the promotional message is further responsive to a correspondence between a set of target demographic parameters and a set of demographic parameters associated with the consumer device.

4. The computer-implemented method of claim 3, wherein the set of target demographic parameters comprises at least one of: user age; user gender; current location; and interests.

5. The computer-implemented method of claim 1, further comprising:
receiving, from the consumer device, an indication that the brand contact has been removed from the address book; and
revoking permission for the selected brand to send promotional messages to the consumer device responsive to receiving the indication.

6. The computer-implemented method of claim 1, further comprising:
receiving, from the consumer device, a request to revoke permission for the selected brand to send promotional messages to the consumer device; and
revoking permission for the selected brand to send promotional messages to the consumer device responsive to receiving the request, wherein the brand contact remains in the address book of the consumer device.

7. The computer-implemented method of claim 6, further comprising:
receiving a request to restore permission for the selected brand to send promotional messages to the consumer device; and
restoring permission for the selected brand to send promotional messages to the consumer device, responsive to receiving the request.

8. A non-transitory computer readable medium storing executable computer program instructions for providing an opt-in system for promotional messages, the computer program instructions comprising instructions for:
detecting, at a consumer device, addition of a brand contact to an address book of the consumer device, the brand contact identifying a selected brand and indicating permission for the selected brand to send promotional messages to the consumer device;
transmitting, to a server, a message, the message comprising an indication of the brand contact;
receiving, at the consumer device, one or more promotional messages, at least one of the one or more promotional messages corresponding to the selected brand identified by the brand contact; and
presenting, at the consumer device, the one or more promotional messages.

9. The non-transitory computer readable medium of claim 8, wherein the addition of the brand contact to the address book comprises:
presenting, at the consumer device, a consumer dashboard, the consumer dashboard comprising representations of a plurality of brands; and
selecting the selected brand from among the plurality of brands, responsive to user input; and
adding the brand contact, identifying the selected brand, to the address book of the consumer device.

10. The non-transitory computer readable medium of claim 8, wherein the message further comprises a request for the one or more promotional messages.

11. The non-transitory computer readable medium of claim 8, wherein the one or more promotional messages are selected based on a set of demographic parameters associated with the consumer device.

12. The non-transitory computer readable medium of claim 11, wherein the set of demographic parameters comprises at least one of: user age; user gender; current location; and interests.

13. The non-transitory computer readable medium of claim 11, wherein the message further comprises the set of demographic parameters.

14. The non-transitory computer readable medium of claim 11, wherein a second consumer device, corresponding to a same user as the consumer device, is associated with a different set of demographic parameters.

15. The non-transitory computer readable medium of claim 8, wherein the computer program instructions further comprise instructions for:
revoking permission for the selected brand to send promotional messages to the consumer device responsive to the brand contact being removed from the address book.

16. The non-transitory computer readable medium of claim 8, wherein the computer program instructions further comprise instructions for:
providing a user interface at the consumer device, the user interface comprising a control to revoke permission for the selected brand to send promotional messages to the consumer device without removing the brand contact from the address book.

17. The non-transitory computer readable medium of claim 16, wherein the user interface further comprises a control to restore permission for the selected brand to send promotional messages to the consumer device.

18. A computer-based system for providing an opt-in system for promotional messages, the system comprising:
a non-transitory computer-readable storage medium comprising executable computer program code for:
a campaign management module configured to create a promotional campaign responsive to instructions received from a brand device, the promotional campaign comprising a promotional message and a brand identifier, the brand identifier uniquely identifying a brand,
a subscription module configured to identify a consumer device that has provided permission to receive promotional messages from the brand by adding a brand contact including the brand identifier to an address book of the consumer device, and
a distribution module configured to transmit the promotional message to the consumer device; and
a processor for executing the computer executable program code.

19. The computer-implemented system of claim 18, wherein the promotional campaign further comprises target demographic parameters and the distribution module is further configured to transmit the promotional message responsive to a correspondence between the target demographic parameters and demographic parameters associated with the consumer device.

20. The computer-implemented system of claim 19, wherein the target demographic parameters comprise at least one of: user age; user gender; current location; and interests.

21. The computer-implemented system of claim 18, further comprising:
a database configured to store a device identifier in conjunction with the brand identifier, the device identifier uniquely identifying the consumer device,
wherein the subscription module identifies the consumer device using the database.

22. The computer-implemented system of claim 18, wherein the subscription module identifies the consumer device responsive to receiving a request for promotional messages from the consumer device, the request including the brand identifier, the request being deleted after the promotional message is transmitted.

23. A computer-implemented method for providing an opt-in system for promotional messages, the method, executed by one or more processors, comprising:
detecting, at a consumer device, addition of a brand contact to an address book of the consumer device, the brand contact identifying a selected brand and indicating permission for the selected brand to send promotional messages to the consumer device;
transmitting, to a server, a message, the message comprising an indication of the brand contact;
receiving, at the consumer device, one or more promotional messages, at least one of the one or more promotional messages corresponding to the selected brand identified by the brand contact; and
presenting, at the consumer device, the one or more promotional messages.

24. The computer-implemented method of claim 23, wherein the addition of the brand contact to the address book comprises:
presenting, at the consumer device, a consumer dashboard, the consumer dashboard comprising representations of a plurality of brands; and
selecting the selected brand from among the plurality of brands, responsive to user input; and
adding the brand contact, identifying the selected brand, to the address book of the consumer device.

25. The computer-implemented method of claim 23, wherein the message further comprises a request for the one or more promotional messages.

26. The computer-implemented method of claim 23, wherein the one or more promotional messages are selected based on a set of demographic parameters associated with the consumer device.

27. The computer-implemented method of claim 26, wherein the set of demographic parameters comprises at least one of: user age; user gender; current location; and interests.

28. The computer implemented method of claim 26, wherein the message further comprises the set of demographic parameters.

29. The computer-implemented method of claim 26, wherein a second consumer device, corresponding to a same user as the consumer device, is associated with a different set of demographic parameters.

30. The computer-implemented method of claim 23, further comprising:
revoking permission for the selected brand to send promotional messages to the consumer device responsive to the brand contact being removed from the address book.

31. The computer-implemented method of claim 23, further comprising:
providing a user interface at the consumer device, the user interface comprising a control to revoke permission for the selected brand to send promotional messages to the consumer device without removing the brand contact from the address book.

32. The computer-implemented method of claim 31, wherein the user interface further comprises a control to restore permission for the selected brand to send promotional messages to the consumer device.
